(19) United States
(12) Patent Application Publication
(10) Pub. No.: US 2012/0297336 A1
(43) Pub. Date: Nov. 22, 2012

(54) COMPUTER SYSTEM WITH TOUCH SCREEN AND ASSOCIATED WINDOW RESIZING METHOD

(75) Inventors: Hung-Yi Lin, Taipei City (TW); Meng-Ju Lu, Taipei City (TW)

(73) Assignee: ASUSTek COMPUTER INC., Taipei (TW)

(21) Appl. No.: 13/462,985

(22) Filed: May 3, 2012

(30) Foreign Application Priority Data
May 16, 2011 (TW) 100117113

(51) Int. Cl. G06F 3/048

(52) U.S. Cl. 715/800

(57) ABSTRACT

A computer system with a touch screen is provided. The computer system includes a touch unit, a hook unit, and a controlling application program. The touch unit generates a position signal according to the touch point. The hook unit is used for judging whether the first position is near a border of a to-be-resized window according to the position signal. If the first position is not near the border, a left button pressing event at the first position and a left button releasing event at the first position are generated. If the first position is near the border, the left button pressing event at the second position, a continuous motion event corresponding to the movement from the second position to a third position and the left button releasing event at the third position are sequentially generated.

This application claims the benefit of Taiwan Patent Application No. 100117113, filed May 16, 2011, the subject matter of which is incorporated herein by reference.

### FIELD OF THE INVENTION

The present invention relates to a computer system, and more particularly to a computer system with a touch screen. The present invention also relates to a window resizing method of the computer system.

### BACKGROUND OF THE INVENTION

Generally, the operating system of the current computer system may allow the user to resize the window. As known, the size of the window shown on the display screen may be adjusted by operating a mouse. Please refer to FIGS. 1A and 1B, which schematically illustrate an action of resizing a window by a using mouse. A toolbar 110 of the operating system is shown on the display screen 100 of the computer system. The toolbar 110 has several user interfaces, for example including a start button 112 and a network status icon 114. In addition, a window 120 is shown on the display screen 100.

Basically, as the mouse is moved, the cursor 150a shown on the window 120 is correspondingly moved. For adjusting the size of the window 120, the user may firstly locate the cursor at a border of the window 120. As shown in FIG. 1A, when the cursor 150b is located at a right border (or a left border) of the window 120, the cursor 150b turns into a double arrow. By sequentially pressing and holding the left mouse button, moving the cursor 150b′ to a new right border and releasing the left mouse button, the width of the window 120 is adjusted.

Similarly, as shown in FIG. 1B, when the cursor 150c is located at a bottom border (or a top border) of the window 120, the cursor 150c turns into a double arrow. By sequentially pressing and holding the left mouse button, moving the cursor 150c to a new bottom border and releasing the left mouse button, the height of the window 120 is adjusted. Similarly, when the cursor 150d is located at one of the four corners of the window 120, the cursor 150d turns into a double arrow. By pressing and holding the left mouse button, moving the cursor 150d to a new position and releasing the left mouse button, the width and the height of the window 120 are both adjusted.

Since the border of the window 120 is very thin and has a width of about 2˜5 pixels, the use of the mouse is able to precisely move the cursor to the border of the window 120.

With increasing development of science and technology, the operating system of the current computer system is able to support the touch screen technology. Recently, the touch screen gradually replaces the conventional mouse to control the computer system. By touching the touch screen with one or more fingers, the functions of the cursor control are achieved. For complying with the touch screen technology, the computer system has a touch screen signal processing device for converting a touching action of the user into a corresponding mouse action.

FIG. 2 is a schematic functional block diagram illustrating the architecture of a touch screen signal processing device used in the conventional computer system with a touch screen. As shown in FIG. 2, the touch screen signal processing device comprises a touch unit 200, an input unit 206, and a controlling application program 210. The touch unit 200 comprises a touch screen 202 and a driver 204. The input unit 206 is used for receiving a position signal from the touch unit 200 through an application program interface (API) 220. Of course, the input unit 206 may receive signals from other hardware components (e.g. a keyboard or a handwriting pen). Each of the driver 204, the input unit 206 and the controlling application program 210 may be selected from a firmware program or a software program. The operations of the touch unit 200 will be illustrated in more details as follows.

In a case that a touch point is generated on the touch screen 202 by the user, the driver 204 generates a corresponding position signal. The position signal may be a coordinate signal. Moreover, according to the position signal from the touch unit 204 through the API 200, the input unit 206 generates a corresponding mouse motion event. The mouse motion event is for example a left button pressing event, a left button releasing event or a continuous moving event.

For example, the controlling application program 210 is a windows control application program provided by the Microsoft Windows operating system. The controlling application program 210 is an application program for processing the mouse motion. According to the mouse motion event generated by the input unit 206, the controlling application program 210 executes a corresponding action.

FIG. 3 schematically illustrates an action of resizing a window by touching the touch screen with a finger. By sequentially placing the user's finger on a first border position 160a of a right border (or a left border) of the window 120, moving the finger to a second border position 160b and letting the finger leave from the touch screen 102, the width of the window 120 is adjusted. The way of adjusting the height of the window 120 and the way of adjusting both the width and the height of the window 120 are similar to the way of adjusting the width, and are not redundantly described herein.

Hereinafter, the conventional window resizing method will be illustrated in more details with reference to FIGS. 2 and 3.

When the touch point generated by the user's finger is located at the first border position 160a of the window 120, the touch unit 200 issues an initial position signal of the touch point to the input unit 206. According to the initial position signal, the input unit 206 generates a left button pressing event and transmits the left button pressing event to the controlling application program 210. Since the initial position signal corresponds to the first border position 160a of the window 120, the controlling application program 210 may consider that the user performs a left button pressing action at the first border position 160a of the window 120. That is, the controlling application program 210 considers that the width of the window 120 will be adjusted.

By sequentially moving the touch point from the first border position 160a to the second border position 160b and letting the finger leave from the touch screen 102, the touch unit 200 successively issues some moving position signals and a final position signal to the input unit 206. According to the moving position signals, the input unit 206 generates a continuous moving event. In addition, the continuous moving event, the initial position signal and the final position signal are transmitted from the input unit 206 to the controlling application program 210. Consequently, the controlling application program 210 may consider that the user is moving the mouse cursor from the first border position 160a to the second border position 160b and the width of the window 120 is being adjusted.

Moreover, according to the final position signal, the input unit 206 generates a left button releasing event. The left button releasing event corresponding to the final position signal is transmitted to the controlling application program 210. Consequently, the controlling application program 210 may consider that the user is releasing the mouse left button at the second border position 160b and the operation of adjusting the width of the window 120 is completed. Meanwhile, the second border position 160b is defined as a position of the new right border of the window 120.

As known, the performance of the conventional window resizing method is dependent on the situation whether the touch point of the user is precisely in contact with the border of the window 120 or not. However, since the area of the finger is too large, it is difficult to precisely handle the position of the touch point. In some occasions, even if the user feels that the finger is placed on the border of the window 120, the actual position signal outputted from the touch unit 200 does not indicate that the touch point is located at the border of the window 120. Under this circumstance, the size of the window 120 fails to be adjusted by moving the position of the touch point. In other words, the conventional window resizing method is not user-friendly.

### SUMMARY OF THE INVENTION

An embodiment of the present invention provides a window resizing method for a touch screen of a computer system. The window resizing method includes the following steps. Firstly, a left button pressing event is generated according to a touch point at a first position of the touch screen. If the first position is near a border of a to-be-resized window, the first position is changed into a second position, which is located at the border of the to-be-resized window. If a left button releasing event at the first position is generated, the left button pressing event at the first position and the left button releasing event at the first position are sequentially outputted. If the left button releasing event at the first position is not generated, the left button pressing event at the second position, a continuous motion event corresponding to a movement from the second position to a third position and the left button releasing event at the third position are sequentially outputted.

Another embodiment of the present invention provides a computer system with a touch screen. The computer system includes a touch unit, a hook unit, and a controlling application program. The touch unit is for generating a position signal according to the touch point. The hook unit is used for judging whether the first position is near a border of a to-be-resized window according to the position signal, thereby determining whether a left button pressing event at the first position and a left button releasing event at the first position are generated or determining whether the left button pressing event at a second position, a continuous motion event corresponding to the movement from the second position to a third position and the left button releasing event at the third position are sequentially generated. The first position is changed into the second position by the hook unit, wherein the second position is located at the border of the to-be-resized window. The controlling application program is used for receiving and executing the left button pressing event, the continuous motion event or the left button releasing event that is outputted from the hook unit.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIGS. 1A and 1B (prior art) schematically illustrate an action of resizing a window by a using mouse;

FIG. 2 (prior art) is a schematic functional block diagram illustrating the architecture of a touch screen signal processing device used in the conventional computer system with a touch screen;

FIG. 3 (prior art) schematically illustrates an action of resizing a window by touching the touch screen with a finger;

FIG. 4 is a schematic functional block diagram illustrating the architecture of a touch screen signal processing device used in the computer system with a touch screen according to an embodiment of the present invention;

FIG. 5 is a flowchart illustrating a window resizing method for use in the touch screen signal processing device of the present invention;

FIGS. 6A, 6B and 6C schematically illustrate some ways of resizing the window of the touch screen according to an embodiment of the present invention;

FIGS. 7A, 7B, 7C and 7D schematically illustrate some ways of resizing the window of the touch screen according to an embodiment of the present invention, in which a plurality of windows are simultaneously shown on the touch screen; and

FIG. 8 is a flowchart illustrating a process of judging whether the first position is near the border of the to-be-resized window according to an embodiment of the present invention.

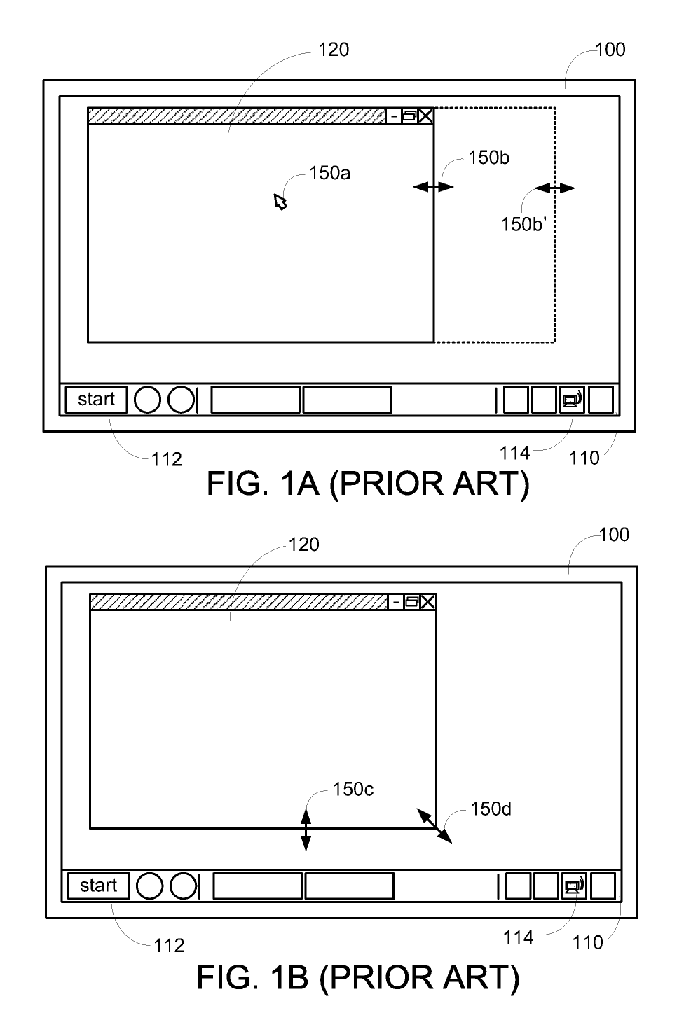

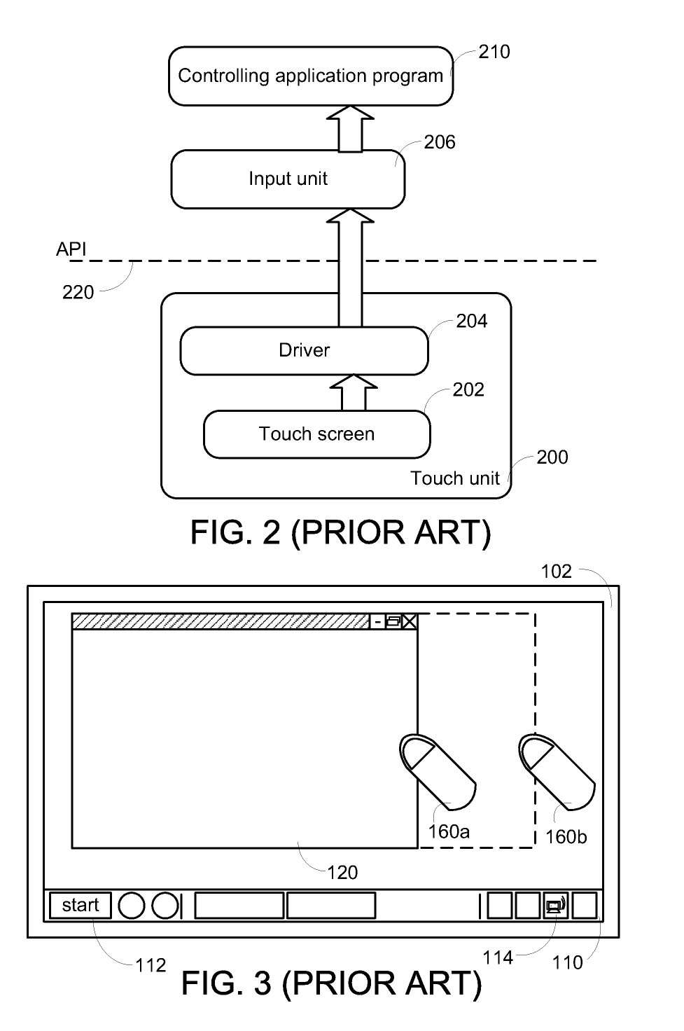

### DETAILED DESCRIPTION OF PREFERRED EMBODIMENTS

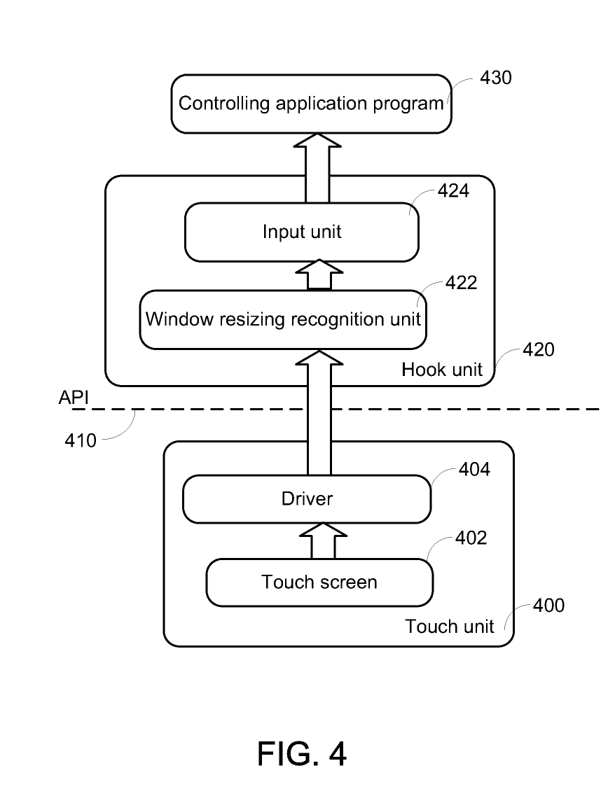

FIG. 4 is a schematic functional block diagram illustrating the architecture of a touch screen signal processing device used in the computer system with a touch screen according to an embodiment of the present invention. As shown in FIG. 4, the touch screen signal processing device comprises a touch unit 400, a hook unit 420, and a controlling application program 430. The touch unit 400 comprises a touch screen 402 and a driver 404. The hook unit 420 comprises a window resizing recognition unit 422 and an input unit 424. The hook unit 420 may receive the position signal from the touch unit 400 through the application program interface (API) 410. In an embodiment, each of the driver 404, the hook unit 420 and the controlling application program 430 is selected from a firmware program or a software program.

In a case that a touch point is generated on the touch screen 402, the driver 404 generates a corresponding position signal. The position signal may be a coordinate signal.

After the position signal from the touch unit 400 is received by the hook unit 420 through the API 410, the window resizing recognition unit 422 of the hook unit 420 will judge whether the touch point is near a border of a to-be-resized window or not. That is, in a case that the user generates a touch point at a first position, the window resizing recognition unit 422 will judge whether the first position is near the border of the to-be-resized window or not. If the first position is not near the border of the to-be-resized window, the window resizing recognition unit 422 will directly transmit the current position signal and the subsequent position signals to the input unit 424. Consequently, the input device 424 generates a corresponding mouse motion event at the first position.

On the other hand, if the first position is near the border of the to-be-resized window, the window resizing recognition unit 422 may assume that a window resizing operation will be done. Consequently, the window resizing recognition unit 422 will adjust the position of the touch point from the first position to a second position, wherein the second position is located at the border of the to-be-resized window. Then, according to the subsequent position signal outputted from the touch unit 400, the window resizing recognition unit 422 may judge whether the user wants to resize the window or not.

In a case that the user does not want to resize the window, the position signal corresponding to the original touch point at the first position and the subsequent position signal outputted from the touch unit 400 are directly transmitted to the input unit 424. Consequently, the input unit 424 generates a corresponding mouse motion event.

In a case that the user really wants to resize the window, the position signal corresponding to the second position and the position signal corresponding to a third position are transmitted to the input unit 424. Consequently, the input unit 424 sequentially generates a left button pressing event, a continuous motion event and a left button releasing event.

Of course, according to the mouse motion event generated by the input unit 424, the controlling application program 430 executes a corresponding action.

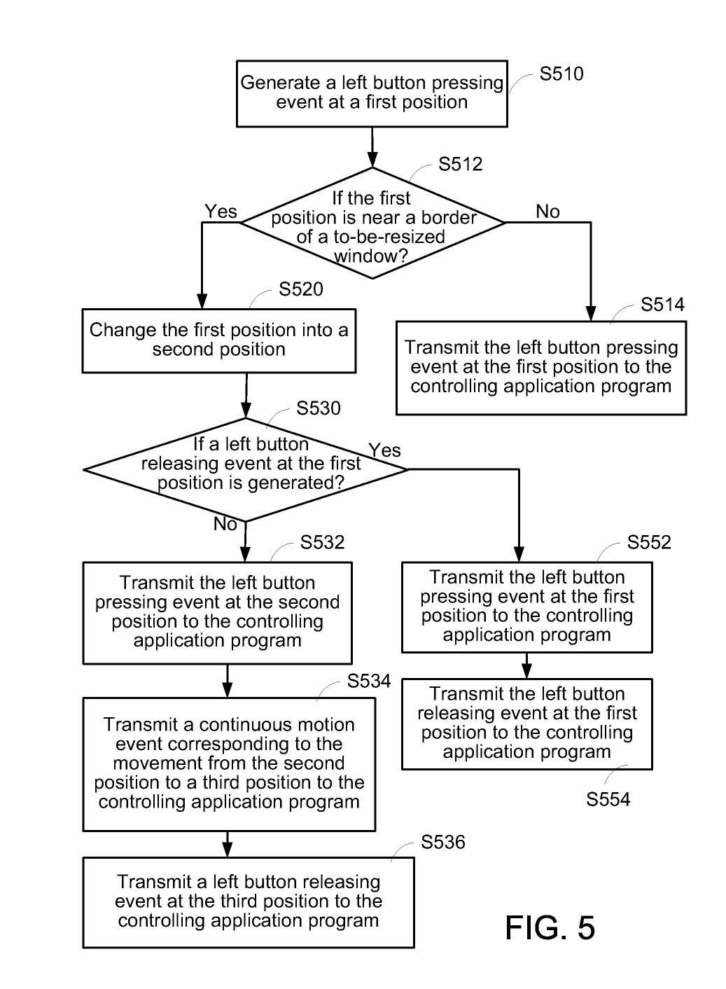

FIG. 5 is a flowchart illustrating a window resizing method for use in the touch screen signal processing device of the present invention. Firstly, when a touch point at a first position of the touch screen is generated, the window resizing recognition unit 422 generates a left button pressing event at the first position according to the position signal outputted from the touch unit 400 (Step S510).

Then, the step S512 is performed to judge whether the first position is near a border of a to-be-resized window or not. In a case that a predetermined range relative to the first position is not in contact with the border of the to-be-resized window, the window resizing recognition unit 422 may judge that the first position is not near the border of the to-be-resized window. Whereas, in a case that the predetermined range relative to the first position is in contact with the border of the to-be-resized window, the window resizing recognition unit 422 may judge that the first position is near the border of the to-be-resized window.

If the first position is not near the border of the to-be-resized window, the subsequent operation will no longer be judged by the window resizing recognition unit 422. Meanwhile, the left button pressing event at the first position is directly transmitted to the controlling application program 430 (Step S514). Moreover, according to the subsequent position signal from the touch unit 400, the input unit 424 generates a corresponding mouse motion event to the controlling application program 430. When a next left button pressing event is generated, the step S510 is repeatedly done.

If the first position is near the border of the to-be-resized window, it means that the user may intend to resize the window. Consequently, the window resizing recognition unit 422 will change the first position into a second position (Step S520). The second position is located at the border of the to-be-resized window. In addition, according to the subsequent operation of the user, the window resizing recognition unit 422 will judge whether the user wants to resize the window or not, thereby determining whether either the left button pressing event at the first position or the left button pressing event at the second position is transmitted to the controlling application program 430.

In a case that the touch point is not moved in the subsequent operation but the touch point is departed from the touch screen, it means that the user does not want to resize the window. Whereas, in a case that the touch point is moved on the touch screen in the subsequent operation, it means that the user wants to resize the window. Consequently, after the step S520, the window resizing recognition unit 422 will judge whether a left button releasing event at the first position is generated according to the position signal outputted from the touch unit 400 (Step S530)

In a case that the window resizing recognition unit 422 generates the left button releasing event at the first position, it means that the user does not want to resize the window. Consequently, the above left button pressing event at the first position is transmitted from the window resizing recognition unit 422 to the controlling application program 430 (Step S552). After the step S552, the left button releasing event at the first position is transmitted from the window resizing recognition unit 422 to the controlling application program 430 (Step S554). When a next left button pressing event is generated, the step S510 is repeatedly done.

In a case that the window resizing recognition unit 422 does not generate the left button releasing event at the first position, it means that the window resizing recognition unit 422 generates a continuous motion event. In other words, the touch point of the user is moved from the first position to a third position and then departed from the touch screen. For smoothly resizing the window, the window resizing recognition unit 422 will transmit the left button pressing event to the controlling application program 430 (Step S532). After the step S532, the continuous motion event corresponding to the movement from the second position to the third position will be transmitted from the window resizing recognition unit 422 to the controlling application program 430 (Step S534). After the step S534, a left button releasing event at the third position is transmitted to the controlling application program 430 (Step S536). When a next left button pressing event is generated, the step S510 is repeatedly done.

From the above discussion, if the touch point at the first location is near the border of the to-be-resized window, the hook unit of the touch screen signal processing device of the present invention may change the first position into a second position, which is located at the border of the to-be-resized window. According to the subsequent operation of the user, the window resizing recognition unit will judge whether the user wants to resize the window or not. Consequently, either the left button pressing event at the first position or the left button pressing event at the second position is transmitted to the controlling application program 430.

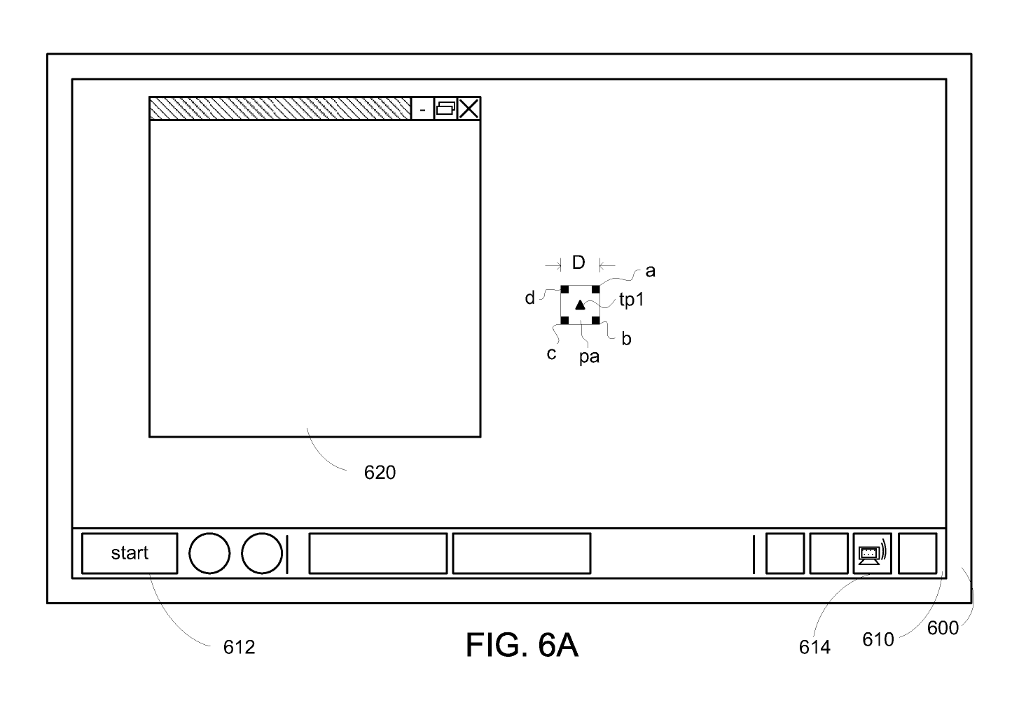

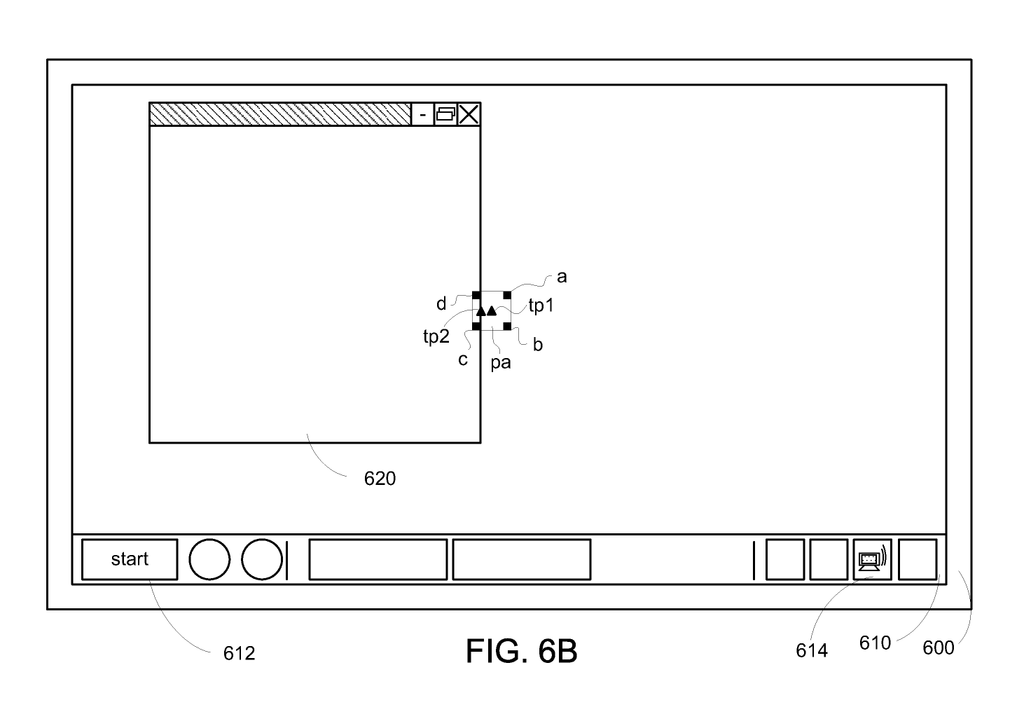

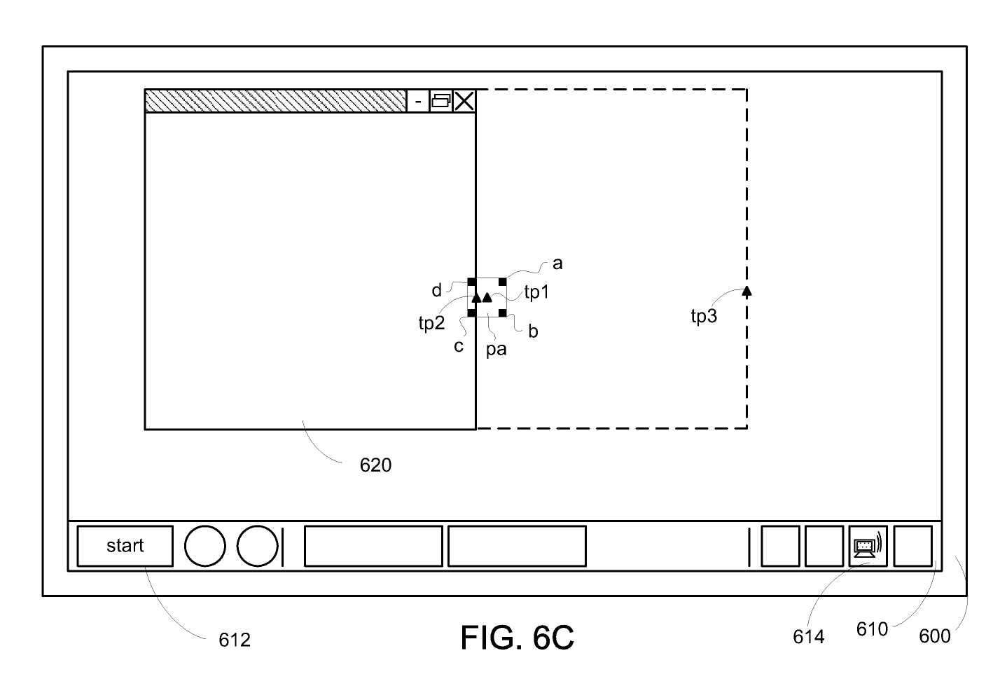

Hereinafter, an exemplary window resizing method will be illustrated with reference to FIGS. 6A, 6B and 6C. As shown in FIGS. 6A, 6B and 6C, a toolbar 610 of the operating system is shown on the touch screen 600 of the computer system. The toolbar 610 has several user interfaces, for example including a start button 612 and a network status icon 614. In addition, a window 620 is shown on the touch screen 600.

As shown in FIG. 6A, the user generates a touch point tp1 (as is indicated by a triangular mark) at the first position of the touch screen. Then, a predetermined range pa whose center is located at the touch point tp1 is defined by the window resizing recognition unit 422. For example, the predetermined range pa is a square with four corners a, b, c and d, and the length of each side is 0.5 cm. It is noted that the shape of the predetermined range may be varied according to the practical requirements.

As shown in FIG. 6A, the touch point tp1 and the predetermined range pa are not in contact with the window 620. It means that the first position corresponding to the left button pressing event is not near the border of the window 620. Consequently, the left button pressing event at the first position is directly transmitted to the controlling application program 430. Meanwhile, the steps S510, S512 and S514 have been done.

Similarly, if the touch point tp1 and the predetermined range pa are completely within the window 620, the steps S510, S512 and S514 are sequentially done.

As shown in FIG. 6B, the user generates a touch point tp1 (as is indicated by a triangular mark) at the first position of the touch screen.

Obviously, the touch point tp1 at the first position is not in contact with the border of the window 620, but two corners c and d of the predetermined range pa are in contact with the border of the window 620. That is, the touch point tp1 is near the right border of the window 620. Consequently, the window resizing recognition unit 422 will calculate a touch point pt2 at a second position, which is located at the right border of the window 620.

Moreover, as shown in FIG. 6B, the touch point tp1 at the first position is not moved. That is, after the touch point tp1 at the first position is generated, the touch point tp1 is departed from the touch screen. Under this circumstance, the window resizing recognition unit 422 confirms that the window 620 is not being resized. Consequently, the left button pressing event at the first position and the left button releasing event at the first position are directly transmitted from the window resizing recognition unit 422 to the controlling application program 430. That is, the steps S510, S512, S520, S530, S552 and S554 are sequentially done.

As shown in FIG. 6C, the user generates a touch point tp1 (as is indicated by a triangular mark) at the first position of the touch screen. Obviously, the touch point tp1 at the first position is not in contact with the border of the window 620, but two corners c and d of the predetermined range pa are in contact with the border of the window 620. That is, the touch point tp1 is near the right border of the window 620. Consequently, the window resizing recognition unit 422 will calculate a touch point pt2 at a second position, which is located at the right border of the window 620.

Moreover, as shown in FIG. 6C, the touch point tp1 at the first position is moved to the touch point tp3 at a third position. Under this circumstance, the window resizing recognition unit 422 confirms that the window 620 is being resized. Consequently, the left button pressing event at the second position, the continuous motion event corresponding to the movement from the second position to the third position and the left button releasing event at the third position are transmitted from the window resizing recognition unit 422 to the controlling application program 430. Meanwhile, the right border of the window 620 is adjusted by the controlling application program 430. That is, the steps S510, S512, S520, S530, S532, S534 and S536 are sequentially done.

Similarly, in a case that the two corners a and d of the predetermined range pa are in contact with the border of the window 620, the window resizing recognition unit 422 may confirm that the touch point tp1 is near the bottom border of the window 620. Consequently, the window resizing recognition unit 422 will calculate a touch point pt2 at a second position, which is located at the bottom border of the window 620. Similarly, in a case that a corner d of the predetermined range pa is in contact with the border of the window 620, the window resizing recognition unit 422 may confirm that the touch point tp1 is near the lower right corner of the window 620. Consequently, the window resizing recognition unit 422 will calculate a touch point pt2 at a second position, which is located at the lower right corner of the window 620.

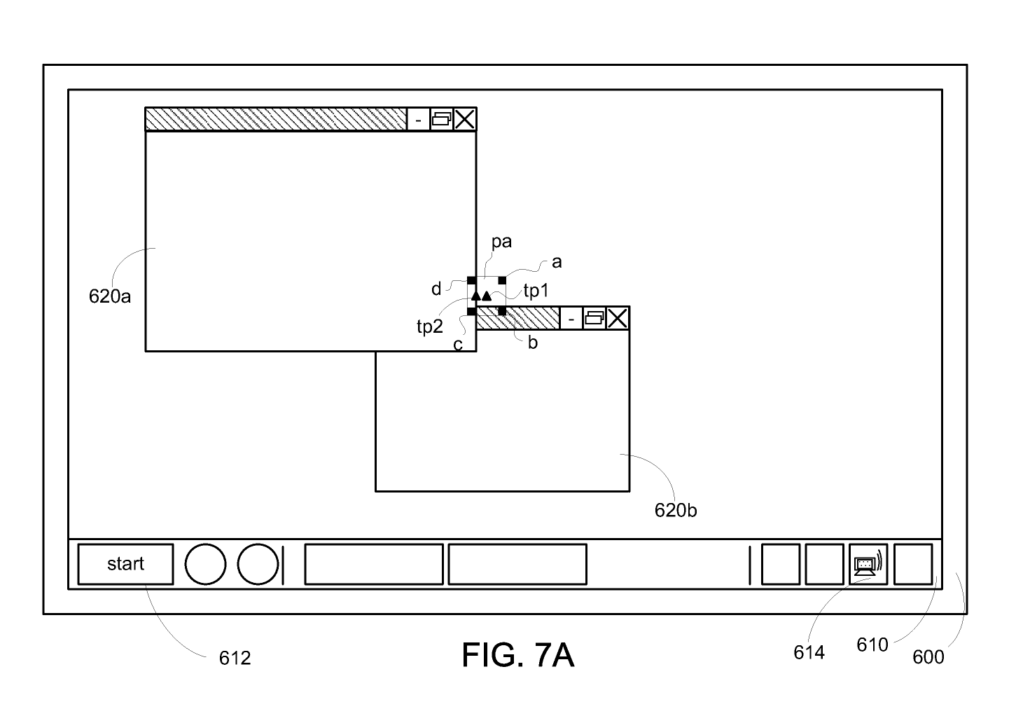

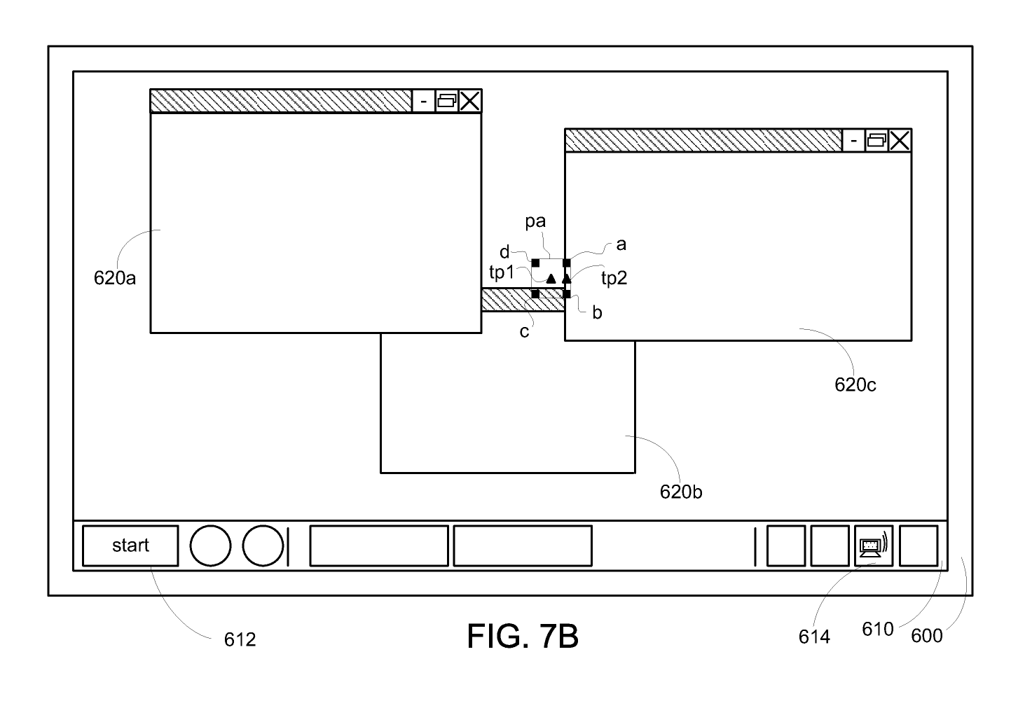

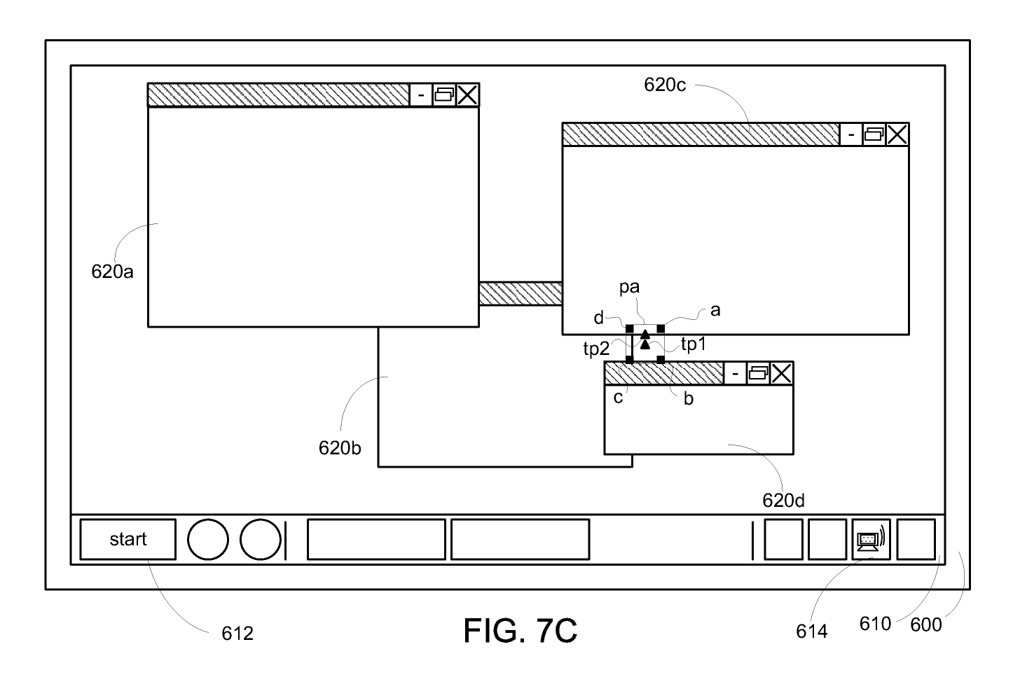

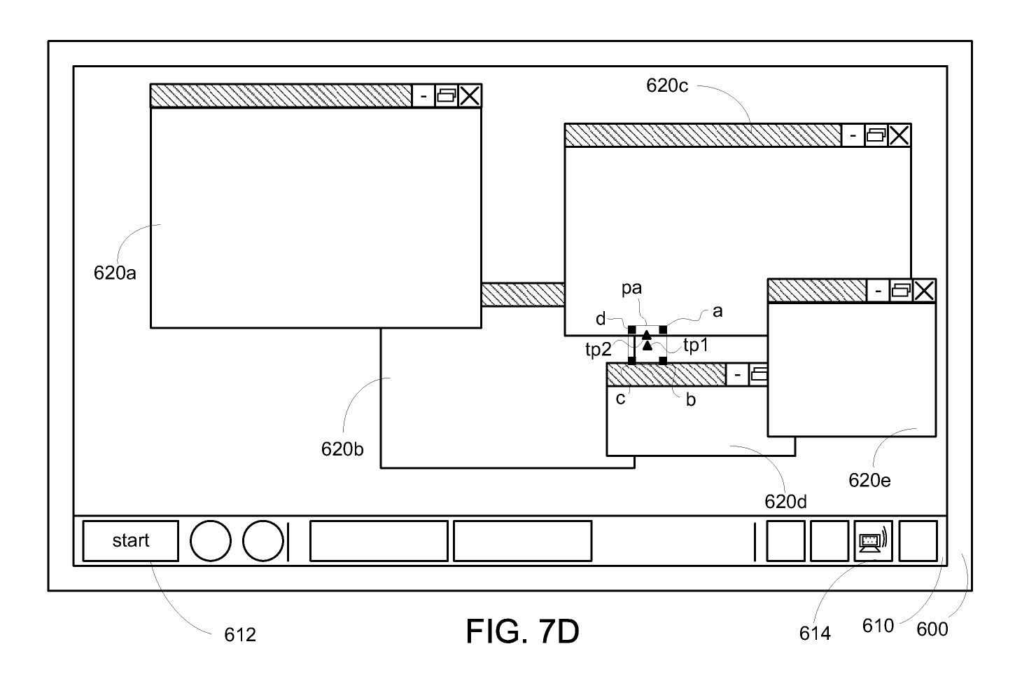

In some other situations, a plurality of windows may be simultaneously shown on the touch screen. FIGS. 7A, 7B, 7C and 7D schematically illustrate some ways of resizing the window of the touch screen according to an embodiment of the present invention, in which a plurality of windows are simultaneously shown on the touch screen. These drawings illustrate how to determine the to-be-resized window and judge whether the first position is near a border of the to-be-resized window.

As shown in FIG. 7A, a first window 620a and a second window 620b are simultaneously shown on the touch screen 600. In addition, the predetermined range pa is in contact with both of the first window 620a and the second window 620b. Obviously, the first window 620a is the active window that is being operated by the user. Consequently, the first window 620a is set as the to-be-resized window, and the touch point tp2 at the second position is located at the right border of the first window 620a.

As shown in FIG. 7B, a first window 620a, a second window 620b and a third window 620c are simultaneously shown on the touch screen 600. The first window 620a is the active window. In addition, the predetermined range pa is in contact with both of the second window 620b and the third window 620c. The second window 620b is partially covered by the third window 620c. Consequently, the third window 620c is set as the to-be-resized window, and the touch point tp2 at the second position is located at the left border of the third window 620c.

As shown in FIG. 7C, a first window 620a, a second window 620b, a third window 620c and a fourth window 620d are simultaneously shown on the touch screen 600. The first window 620a is the active window. In addition, the predetermined range pa is in contact with the second window 620b, the third window 620c and the fourth window 620d. In addition, the second window 620b is partially covered by the third window 620c and the fourth window 620d. Under this circumstance, it is necessary to further determine whether the third window 620c or the fourth window 620d is the to-be-resized window.

Since the bottom border of the third window 620c is closer to the touch point tp1 than the top border of the fourth window 620d, the third window 620c is set as the to-be-resized window, and the touch point tp2 at the second position is located at the bottom border of the third window 620c.

As shown in FIG. 7D, a first window 620a, a second window 620b, a third window 620c, a fourth window 620d and a fifth window 620e are simultaneously shown on the touch screen 600. The first window 620a is the active window. In addition, the predetermined range pa is in contact with the second window 620b, the third window 620c and the fourth window 620d. In addition, the third window 620c and the fourth window 620d are partially covered by the fifth window 620e. Since the fifth window 620e is not in contact with the predetermined range pa, it is only necessary to judge whether the second window 620b, the third window 620c and the fourth window 620d are covered by each other. Like the situation of FIG. 7C, the third window 620c is set as the to-be-resized window, and the touch point tp2 at the second position is located at the bottom border of the third window 620c.

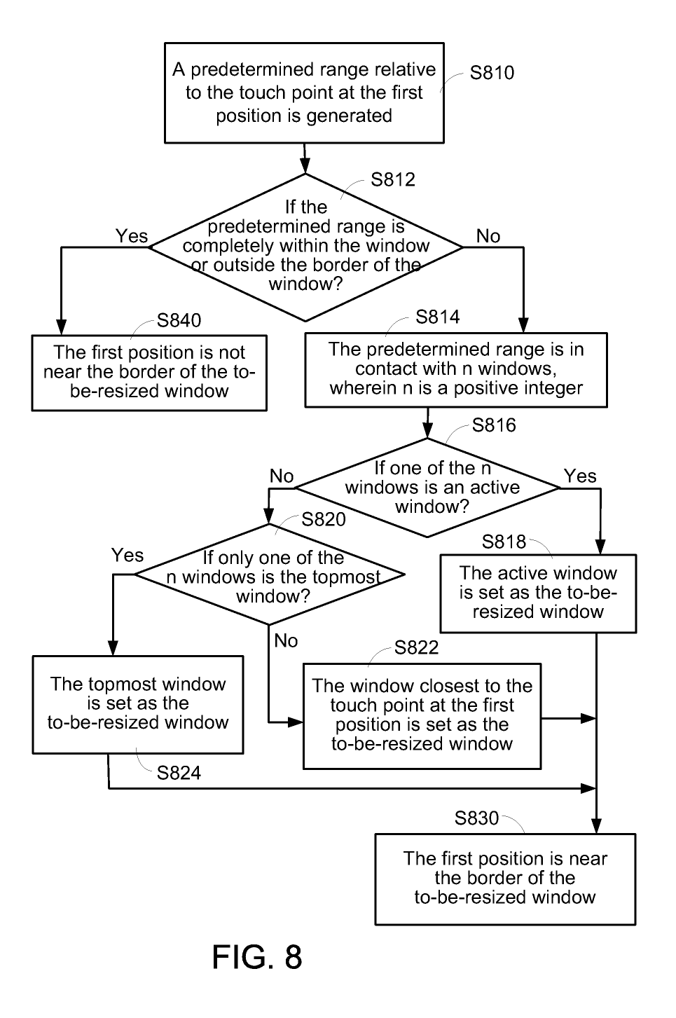

FIG. 8 is a flowchart illustrating a process of judging whether the first position is near the border of the to-be-resized window according to an embodiment of the present invention.

Firstly, a predetermined range relative to the touch point at the first position is generated (Step S810). Then, the step S812 is performed to judge whether the predetermined range is completely within the window or outside the border of the window.

In a case that the predetermined range is completely within the window or outside the border of the window, it means that the first position is not near the border of the to-be-resized window (Step S840). Whereas, in a case that the judging condition of the step S812 is not satisfied, it means that the predetermined range is in contact with n windows, where n is a positive integer (Step S814).

Then, the step S816 is performed to judge whether one of the n windows is an active window. If one of the n windows is the active window, the active window is set as the to-be-resized window (Step S818). Meanwhile, the first position is confirmed to be near the to-be-resized window (Step S830). For example, as shown in FIG. 7A, the first window 620a is the active window that is being operated by the user, so that the first window 620a is set as the to-be-resized window.

Whereas, if none of the n windows is the active window, the step S820 is performed to judge whether only one of the n windows is the topmost window. That is, the step S820 is performed to judge whether only one of the n windows is not covered by other windows.

If the judging condition of the step S820 is satisfied, the topmost window is set as the to-be-resized window (Step S824), and the first position is confirmed to be near the to-be-resized window (Step S830). For example, as shown in FIG. 7B, the predetermined range pa is in contact with both of the second window 620b and the third window 620c, and the second window 620b is partially covered by the third window 620c. Consequently, the third window 620c is set as the to-be-resized window.

Whereas, if the judging condition of the step S820 is not satisfied, it means that there are two or more topmost windows. That is, two or more windows of the n windows are not covered by other windows. Among these topmost windows, the window closest to the touch point at the first position is set as the to-be-resized window (Step S822), and the first position is confirmed to be near the to-be-resized window (Step S830). For example, as shown in FIG. 7C, the predetermined range pa is in contact with the second window 620b, the third window 620c and the fourth window 620d, and the second window 620b is partially covered by the third window 620c and the fourth window 620d. Under this circumstance, it is necessary to further determine whether the third window 620c or the fourth window 620d is the to-be-resized window. Since the bottom border of the third window 620c is closer to the touch point tp1, the third window 620c is set as the to-be-resized window.

From the above description, the window resizing method of the present invention is capable of resizing a window of a touch screen by judging whether a touch point at a first position is near a border of a to-be-resized window. Even if the touch point at the first position is not located at the border of the to-be-resized window, the window resizing method of the present invention can still implement the window resizing operation. Consequently, the drawbacks resulted from the large contact area of the user's finger can be effectively eliminated, and the size of the window can be smoothly adjusted.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A window resizing method for a touch screen of a computer system, the window resizing method comprising steps of:
generating a left button pressing event according to a touch point at a first position of the touch screen;
judging whether the first position is near a border of a to-be-resized window or not, wherein if the first position is near the border of the to-be-resized window, the first position is changed into a second position, which is located at the border of the to-be-resized window; and
judging whether a left button releasing event at the first position is generated or not, wherein if the left button releasing event at the first position is generated, the left button pressing event at the first position and the left button releasing event at the first position are sequentially outputted, wherein if the left button releasing event at the first position is not generated, the left button pressing event at the second position, a continuous motion event corresponding to a movement from the second position to a third position and the left button releasing event at the third position are sequentially outputted.

2. The window resizing method as claimed in claim 1, wherein the computer system comprises:
a touch unit for generating a position signal according to the touch point;
a hook unit for generating the left button pressing event, the continuous motion event or the left button releasing event according to the position signal, wherein the first position is changed into the second position by the hook unit; and
a controlling application program for receiving and executing the left button pressing event, the continuous motion event or the left button releasing event that is outputted from the hook unit.

3. The window resizing method as claimed in claim 2, wherein the touch unit comprises the touch screen and a driver, wherein the driver generates the position signal according to the touch point.

4. The window resizing method as claimed in claim 2, wherein the hook unit comprises a window resizing recognition unit and an input device, wherein the first position is changed into the second position by the window resizing recognition unit, wherein the left button pressing event, the continuous motion event or the left button releasing event are generated by the input unit.

5. The window resizing method as claimed in claim 1, wherein if the first position is not near the border of the to-be-resized window, the window resizing method further comprises a step of outputting the left button pressing event at the first position.

6. The window resizing method as claimed in claim 1, wherein if the left button releasing event at the first position is not generated, the window resizing method further comprises a step of outputting the continuous motion event corresponding to a movement from the first position to the third position.

7. The window resizing method as claimed in claim 1, wherein the step of judging whether the first position is near the border of the to-be-resized window comprises sub-steps of:
generating a predetermined range relative to the first position according to the touch point at the first position;
judging whether the predetermined range is completely within the window or outside the border of the window or not, wherein if the predetermined range is completely within the window or outside the border of the window, the first position is confirmed not to be near the border of the to-be-resized window, wherein if the predetermined range is not completely within the window or outside the border of the window, the predetermined range is confirmed to be in contact with n windows, where n is a positive integer;
judging whether one of the n windows is an active window after the predetermined range is confirmed to be in contact with the n windows, wherein if one of the n windows is the active window, the active window is set as the to-be-resized window and the first position is confirmed to be near the to-be-resized window; and
judging whether only one of the n windows is the topmost window after none of the n windows is confirmed to be the active window, wherein if only one of the n windows is the topmost window, the topmost window is set as the to-be-resized window and the first position is confirmed to be near the to-be-resized window, wherein if two or more topmost windows of the n windows are topmost windows, the topmost window closest to the touch point at the first position is set as the to-be-resized window and the first position is confirmed to be near the to-be-resized window.

8. A computer system with a touch screen, the computer system comprising:
a touch unit for generating a position signal according to the touch point;
a hook unit for judging whether the first position is near a border of a to-be-resized window according to the position signal, thereby determining whether a left button pressing event at the first position and a left button releasing event at the first position are generated or determining whether the left button pressing event at a second position, a continuous motion event corresponding to the movement from the second position to a third position and the left button releasing event at the third position are sequentially generated, wherein the first position is changed into the second position by the hook unit, and the second position is located at the border of the to-be-resized window; and
a controlling application program for receiving and executing the left button pressing event, the continuous motion event or the left button releasing event that is outputted from the hook unit.

9. The computer system as claimed in claim 8, wherein if the first position is not near the border of the to-be-resized window, the left button pressing event at the first position and the left button releasing event at the first position are generated, wherein if the first position is near the border of the to-be-resized window, the left button pressing event at the second position, the continuous motion event corresponding to the movement from the second position to a third position and the left button releasing event at the third position are sequentially generated.

10. The computer system as claimed in claim 8, wherein the hook judges whether the first position is near the border of the to-be-resized window by steps of:
generating a predetermined range relative to the first position according to the touch point at the first position;
judging whether the predetermined range is completely within the window or outside the border of the window or not, wherein if the predetermined range is completely within the window or outside the border of the window, the first position is confirmed not to be near the border of the to-be-resized window, wherein if the predetermined range is not completely within the window or outside the border of the window, the predetermined range is confirmed to be in contact with n windows, where n is a positive integer;
judging whether one of the n windows is an active window after the predetermined range is confirmed to be in contact with the n windows, wherein if one of the n windows is the active window, the active window is set as the to-be-resized window and the first position is confirmed to be near the to-be-resized window; and
judging whether only one of the n windows is the topmost window after none of the n windows is confirmed to be the active window, wherein if only one of the n windows is the topmost window, the topmost window is set as the to-be-resized window and the first position is confirmed to be near the to-be-resized window, wherein if two or more topmost windows of the n windows are topmost windows, the topmost window closest to the touch point at the first position is set as the to-be-resized window and the first position is confirmed to be near the to-be-resized window.
